(19) United States
(12) Patent Application Publication
(10) Pub. No.: US 2021/0166508 A1
(43) Pub. Date: Jun. 3, 2021

(54) COMMUNICATIONS SYSTEM OF A VEHICLE

(71) Applicant: HUF HÜLSBECK & FÜRST GMBH & CO., Velbert (DE)

(72) Inventor: Boris Ziller, Ratingen (DE)

(73) Assignee: Huf Huelsbeck & Fuerst GmbH & Co. KG, Velbert (DE)

(21) Appl. No.: 16/770,829

(22) PCT Filed: Nov. 15, 2018
(86) PCT No.: PCT/EP2018/081339

§ 371 Date: Jun. 8, 2020

(30) Foreign Application Priority Data
Feb. 2, 2018 (DE) 10 2018 102 405.3

(51) Int. Cl. G07C 9/00; H01Q 1/32

(52) U.S. Cl. CPC G07C 9/00309; H01Q 1/3241; G07C 2209/63; G07C 2009/00769; G07C 2009/00555

(57) ABSTRACT

A communications system of a vehicle that enables the vehicle to communicate with a portable ID transmitter of an operator, which is configured for UWB communication, e.g., via a UWB transceiver, includes at least one first UWB receiver with a first UWB antenna and a second UWB receiver with a second UWB antenna. The first UWB antenna and the second UWB antenna are arranged in a spaced apart manner from one another on the vehicle. The communications system is designed to evaluate UWB signals of the ID transmitter via a central UWB control unit or a central control device.

The invention relates to a communications system of a vehicle. The communications system is used in particular to enable the vehicle to communicate with a portable ID transmitter, which is configured in particular for UWB communication. The communication which can be carried out with the communications system is suitable for contributing to enabling vehicle functions for an operator, if the operator carries the portable ID transmitter with him.

Different access systems based on radio technology are known from the prior art. These are often referred to as keyless access systems, since they can function without a mechanical key bit. Keyless access systems of the type mentioned are based on radio communication of an on-board infrastructure having a portable ID transmitter. As part of the radio communication carried out, an authorized ID transmitter authenticates itself on the vehicle's infrastructure. Authentication of the ID transmitter is typically carried out using cryptographic methods, in particular by exchanging and checking encrypted authorization data.

In the field of keyless access systems, the use of low-frequency (LF) and high-frequency (HF) radio waves is known and commonly used. Combined communication using LF/HF systems is also known from practice. For example, the ID transmitter is first awakened with an LF wake-up signal, whereupon the actual authentication is carried out in the course of HF communication.

In the case of radio-based authorization systems, security is of crucial importance, particularly with regard to compromising the radio communication carried out. A danger to the security of radio-based authentication systems is based on the fundamental disadvantage that an LF radio communication or an HF radio communication can be extended. One type of attack scenario concept, which is based on the forwarding of LF radio communication or HF radio communication, is known, for example, under the term relay station attacks.

In the course of the increasing importance of keyless access systems and against the background of the above explanations, there is a desire to provide communication between ID transmitters and a vehicle with improved security against compromise.

The object of the invention is to provide a concept on the basis of which authentication of an ID transmitter on a vehicle can be carried out with improved security.

The object is achieved with a communications system having the features of claim 1.

The communications system has at least a first UWB receiver and a second UWB receiver.

The communications system contributes to a secure enabling of vehicle functions by supplying an authentication system of the vehicle with information as to whether UWB communication between the ID transmitter and the vehicle may be regarded as authentic communication.

Depending on the overall design of the vehicle, the communications system can be considered either as part of the authentication system or as a system independent of the authentication system.

The first UWB receiver comprises a first UWB antenna; the second UWB receiver comprises a second UWB antenna. It is conceivable that a UWB receiver and a UWB antenna are part of a compact module, for example a UWB transceiver. Alternatively, it is conceivable that a UWB antenna is coupled to other components of a UWB receiver, but is spaced apart from them.

The first UWB antenna and the second UWB antenna are spaced apart from one another on the vehicle.

The spaced-apart arrangement of the UWB antennas on the vehicle is to be understood in such a way that the distance between the UWB antennas is greater than a directly adjacent arrangement of the UWB antennas, for example the distance is at least two centimeters. It is substantial that the first and the second UWB antennas are arranged at different positions of the vehicle and that the distance between the UWB antennas is large enough that when the same signal is received, it results in a runtime difference of the runtimes of the signal from its transmission source to the first UWB antenna and of the signal from its transmission source to the second UWB antenna, wherein said runtime difference can be detected and/or evaluated by the communications system.

All UWB receivers are coupled to a central UWB control unit of the vehicle. A separate unit can be provided as the UWB control unit, but the central control unit of the vehicle or part of the central control unit of the vehicle can also be configured as the UWB control unit.

The communications system is configured for UWB communication with a predefined or a number of predefined ID transmitters, but the ID transmitter itself is not part of the communications system according to the invention.

The central UWB control unit is configured to evaluate both a first reception signal of an ID transmitter UWB signal received by the first UWB antenna and a second reception signal of the same ID transmitter UWB signal received by the second UWB antenna as a function of one another for an authentication of the communication of the vehicle with the ID transmitter.

In other words: Both the first UWB antenna and the second UWB antenna receive the same UWB signal transmitted by the ID transmitter (namely the ID transmitter UWB signal). The communication of the vehicle with the ID transmitter is authenticated on the basis of both the reception signal received at the first UWB antenna and the reception signal received at the second UWB antenna. This means that based on the same transmitted ID transmitter UWB signal, both a reception characteristic on the first UWB antenna and a reception characteristic on the second UWB antenna are detected, both reception characteristics being evaluated jointly by the central UWB control unit, to authenticate the communication of the vehicle with the ID transmitter.

In principle, the use of ultra-wideband radio signals, abbreviated: UWB radio signals, is known from practice. However, it has only recently become available for use in a wide range of applications, not least as a result of more liberal regulation. Along with this, UWB transceivers that can be universally implemented in applications are now commercially available.

Ultra-wideband technology is a type of radio communication that is based on the transmission of short signal pulses. The signal pulses cover a large number of frequencies within a comparatively large frequency bandwidth. The width of the covered frequency ranges is not least limited or dependent on the regulatory requirements of the corresponding territorial area. In order to make ultra-wideband communication usable without disturbing other radio communications, the transmission powers used are generally comparatively low due to regulatory requirements, which is why ultra-wideband technology in the sense mentioned here is a short-range radio communication. UWB radio communication can take place, for example, in a frequency range that lies within the frequency range between 30 MHz and 30 GHz.

At UWB, information transmission is not based on carrier frequency modulation. Instead, other methods of modulation are used, such as on/off keying, pulse amplitude modulation, or pulse position modulation.

Compared to other radio communication, for example compared to LF communication, UWB communication has the basic advantage that a reliable distance determination by means of a runtime-based approach is possible due to the emission of pulses that have a large number of frequencies. This is often referred to as the time-of-flight distance determination. For example, the distance between the UWB antenna of a vehicle and a portable ID transmitter prepared for UWB communication can be determined by sending a UWB signal from the UWB antenna of the vehicle to the portable ID transmitter, a UWB transceiver of the portable ID transmitter answering said signal, and after receiving the response signal by the UWB antenna of the vehicle, a control means coupled to the UWB antenna of the vehicle evaluating the measured runtime. In this example, the route to the ID transmitter, a reaction time within the ID transmitter, and the distance from the ID transmitter to the UWB antenna of the vehicle are taken into account. If, as in this example, the runtime is evaluated on the vehicle side, only the reaction time within the ID transmitter needs to be known on the vehicle side, so that a corresponding correction of the in-vehicle-measured time between transmitting the UWB signal and receiving the UWB response can be made.

Experience has shown that the accuracy of a UWB-based distance determination carried out in this way is significantly higher than is the case with many other methods in the usual range of distances. UWB-based distance determination is usually more precise than a distance determination based on signal strength determination of LF signals or on triangulation of LF signals. The accuracy of the UWB-based distance determination under good conditions is in the order of ten to twenty centimeters.

A major advantage of using the UWB signals is that due to the large number of frequencies used, complete shading of the signals is very unlikely. The reason for this is that there is a very high probability that there is always a line of sight between the transmitter and receiver for at least some of the frequencies used at the same time. Because of the large number of different frequencies used, diffraction effects and/or reflections can be expected in most cases at least for some of the frequencies used.

The present invention takes advantage of the fact that the detection of the same ID transmitter UWB signal with at least two UWB antennas, namely at least the first UWB antenna and the second UWB antenna, can contribute for secure authentication of the communication of the vehicle with the ID transmitter with a subsequent evaluation by the central UWB control unit. In particular, the authentication of the communication between the ID transmitter and the vehicle can be provided as a prerequisite for enabling a vehicle function, so that a vehicle function can only be enabled under the condition that the communication between the ID transmitter and the vehicle is not rejected as not authentic communication. In particular, the central UWB control unit can carry out an evaluation as to whether the first reception signal and the second reception signal can be sent simultaneously by the same ID transmitter, taking into account the spaced-apart positioning of the first UWB antenna from the second UWB antenna (that is known to the central control unit). The precise design of this evaluation is subject to professional action. In one variant, the evaluation can include in particular the distance of the first UWB antenna from the second UWB antenna by taking into account that the reception of the ID transmitter UWB signal at the first UWB antenna and the reception of the ID transmitter UWB signal on the second UWB antenna can have at most one transmission-related runtime difference that corresponds to the distance between the UWB antennas.

Because the first UWB antenna and the second UWB antenna are spaced apart from one another, the UWB control unit can, with the appropriate configuration, include in the evaluation that the positioning of the ID transmitter can be restricted to a corresponding subspace from the order of the UWB antennas that receive the same reception signal in succession. For example, in a communication arrangement with two UWB antennas, it can be concluded that the ID transmitter is located in a half-space that also has that antenna of the two UWB antennas that received the ID transmitter UWB signal first.

Alternatively or additionally, when the central control unit is configured to evaluate the reception signals, knowledge about a directional dependence of the reception sensitivity of the UWB antennas can be received. This means that, for example, the differences in the detected intensities can be evaluated taking into account the different orientation of the UWB antennas, which is known to the central UWB control unit.

The authentication of the ID transmitter on the vehicle, i.e. the test as to whether vehicle functions can be enabled for an operator who carries the portable ID transmitter with him, after ensuring that the communication can be regarded as authentic, i.e. provided that the authentication of the communication was successful, can be carried out in any way with an authentication system of the vehicle on the basis of communication with the ID transmitter. Known methods such as an exchange of cryptographic information between the authentication system and the ID transmitter can be used for this purpose. The cryptographic information can be exchanged, for example, by means of UWB communication between the ID transmitter and one of the UWB antennas, or by means of HF communication between an HF interface of the ID transmitter and an HF interface of the authentication system. The exchange of the cryptographic information can take place independently of the communication between ID transmitter and vehicle explained above, for example before or after in the scope of a UWB communication and/or HF communication which was carried out for this purpose. The exchange of the cryptographic information can alternatively be carried out completely or partially in the context of the communication between ID transmitter and vehicle explained above, that is to say using the ID transmitter UWB signal.

The ID transmitter UWB signal can be, for example, a signal that is used to determine the distance between one of the UWB antennas and the vehicle. Alternatively or additionally, the ID transmitter UWB signal can be a signal with which cryptographic information is transmitted for an authentication of the ID transmitter on the vehicle. Alternatively, the ID transmitter signal can also be sent out specifically for the purpose of confirming the authenticity of the communication, wherein the authentication of the ID transmitter on the vehicle is carried out in addition to checking the authenticity of the communication, for example with a separate UWB communication or with RF communication between an HF interface of the ID transmitter and an RF interface of the authentication system.

According to a variant of the communications system, it can be provided that the direction of a maximum reception sensitivity of the first UWB antenna and the direction of a maximum reception sensitivity of the second UWB antenna are oriented at an angle to one another which is at least 30 degrees. In other words, UWB antennas having a certain directional characteristic are used as part of the communications system; the directional characteristic is taken into account in the positioning of the UWB antennas on the vehicle in such a way that the directions are oriented inclined to one another with respect to the maximum reception sensitivity, so that, for example, a half line directed from the first UWB antenna in the direction of the maximum reception sensitivity of the first UWB antenna and a half line starting from the second UWB antenna in the direction of the maximum reception sensitivity of the second UWB antenna are oriented to one another at an angle which is at least 30 degrees.

The reception signal strengths are influenced accordingly by the deviation of the maximum reception sensitivity.

According to one embodiment, it can be provided that the direction of the maximum reception sensitivity of the first UWB antenna and the direction of the maximum reception sensitivity of the second UWB antenna are oriented at an angle to one another which is at most 120 degrees.

In a preferred embodiment of the communications system, the selection and positioning of the UWB antenna relative to one another is selected such that an overlap space exists in front of a driver's door of the vehicle. Within the overlap space, a reception sensitivity of the first UWB antenna and a reception sensitivity of the second UWB antenna exceed a minimum value at any location, which is in any case greater than zero.

In particular,
an extension of the overlap space,
the selection, positioning and orientation of the UWB antennas, as well
as the selection of a UWB communication arrangement of the ID transmitter
   are selected so that they are matched to one another such that UWB communication with both the first UWB antenna and the second UWB antenna can be carried out for an ID transmitter located within the overlap space.

In other words, by means of the corresponding selection and positioning of the UWB antennas, the communications system is configured such that an ID transmitter can carry out UWB communication with both the first UWB antenna and with the second UWB antenna if the ID transmitter is in a designated location. The designated location or locations are defined as such by the vehicle manufacturer and covered with an overlap space of two or more UWB antennas. The targeted design of one or more overlap spaces ensures that the evaluation of the first reception signal and the second reception signal, which is provided as a function of one another, can be carried out with the central UWB control unit.

The targeted use of UWB antennas with a directional characteristic and the targeted provision of overlap spaces are accompanied by the advantage that the UWB communication of the ID transmitter with the vehicle is locally restricted to one or more regions within which the ID transmitter is to be expected during a typical operating scenario. The certain directional characteristic that is present in many UWB antennas, in other words: anisotropic reception sensitivity, is therefore used in a particularly elegant and preferred manner to provide communication whose compromise is already achieved due to the limited local configuration of the overlap areas.

Another advantage of using UWB antennas with a directional characteristic is that a falsification of a UWB runtime measurement, for example due to reflections, is recognized. The reason for this is that UWB antennas having directional characteristics and when the UWB antennas are positioned at an angle to one another, the probability is low that a reflected ID transmitter UWB signal is received by a plurality of UWB antennas. A reflected signal will thus lead with a certain probability to a runtime difference in the runtime values detected at various UWB antennas, which is greater than a maximum runtime to be explained below.

According to one embodiment, the communication between the ID transmitter and the vehicle is rejected as non-authentic communication, if only exactly one of the UWB antennas registers a reception signal of the ID transmitter UWB signal. In such a case, it cannot be ensured that the signal has not been manipulated. On the other hand, upon receipt, it can only be concluded with a UWB antenna that the operator is most likely not in an overlap space provided by the vehicle provider as the operator's position when the position is left.

Alternatively or additionally, according to an advantageous embodiment, the UWB control unit is configured to evaluate a first runtime value of the first reception signal and a second runtime value of the second reception signal by means of N-lateration, where N is the number of UWB antennas that detect a reception signal from the same ID transmitter UWB signal. In the case of two existing UWB antennas, for example, this means that bilateration is carried out to evaluate the first runtime and the second runtime. In the event that three UWB antennas are present and detect a reception signal, trilateration is carried out, etc.

In order to be able to evaluate a runtime value of a UWB signal, a vehicle UWB signal is preferably first sent to the ID transmitter. The ID transmitter then sends the UWB signal in response. This enables a motor vehicle control unit, for example the UWB control unit, to evaluate the UWB communication over the entire route vehicle->ID transmitter->vehicle. One of the UWB antennas present according to the invention is particularly preferably used for transmitting the vehicle UWB signal.

In an advantageous variant of the communications system, the UWB control unit is configured so that the evaluation of the first reception signal and the second reception signal depends on one another, that a first runtime value of the first reception signal and a second runtime value of the second reception signal is determined and the communication of the vehicle is rejected as non-authentic communication to the ID transmitter if an amount of a runtime difference between the first runtime value and the second runtime value exceeds a maximum runtime by more than a tolerated deviation.

According to a variant, communication between vehicle and ID transmitter is rejected as non-authentic communication if the amount of the runtime difference between the first runtime value and the second runtime value exceeds the maximum runtime by more than the tolerated deviation, and in the other case the communication between vehicle and ID transmitter is accepted as authentic, that is: not corrupt; the authentication of the communication is thus considered successful.

According to a variant, it can be provided that the authentication of the communication is only considered to be successful if additional conditions are also met, the person skilled in the art being able to provide a number of further test instances.

The maximum runtime is the time it takes electromagnetic waves to cover the distance between the first UWB antenna and the second UWB antenna. The trigonometric fact is thus exploited that a path difference of the same UWB signal from the ID transmitter to two spaced-apart UWB antennas for all possible positions of the ID transmitter corresponds to a maximum of the distance of the two UWB antennas from one another. In other words: The runtimes, alternatively or additionally the reception times, at the position of the first UWB antenna and the position of the second UWB antenna are compared with one another and the difference between the two is checked to determine whether these are plausible in relation to the distance of the first UWB antenna from the second UWB antenna, that is to say that a runtime difference between a runtime on the first UWB antenna and a runtime on the second UWB antenna corresponds at most to the distance between the first and the second UWB antenna. In order to be able to cushion any computing times or inaccuracies in the detection of the times or their further electronic processing, a tolerated deviation is provided in one variant. The tolerated deviation defines a tolerance range and can be, for example, 20 percent of the minimum runtime, which is permitted in addition to the maximum runtime.

As the runtime value of the reception signal, a runtime “time of transmission of the interrogation signal of the transmitting UWB antenna->response with ID transmitter UWB signal by ID transmitter->reception time of reception by receiving UWB antenna” can be provided.

A runtime “ID transmitter UWB signal by ID transmitter->time of reception by receiving UWB antenna” can be provided as the runtime value of the reception signal.

Alternatively, a time of reception of the ID transmitter UWB signal at the respective receiving UWB antenna can be provided as the runtime value.

Because the runtime values are determined with reference to two spaced-apart UWB antennas, but based on the reception of the same signal, namely the ID transmitter UWB signal, all of the above-mentioned variants of the runtime value are equivalent and at least lead to the formation of a difference with an ideal consideration of the same runtime difference. Possible, for example device-related, minor deviations from the ideal consideration can be taken into account in the concrete implementation of the invention with the tolerated deviations provided.

According to a preferred embodiment of the communications system, the UWB control unit is configured as pad of the evaluation of the first reception signal and the second reception signal as a function of one another
to determine a runtime value for each of the reception signals and to calculate a mean runtime value from the determined runtime values, and/or
to determine a signal strength value, for example an RSSI value, for each of the reception signals and to calculate a mean signal strength value from the determined signal strength values, wherein a mean UWB distance value is derived from the mean runtime value and/or from the mean signal strength value.

The mean distance value is preferably an average value from the determined distances, the distance of the ID transmitter to each of the UWB antennas which have detected a reception signal being determined over the runtime of the UWB signal. Preferably, only one of the available UWB antennas is used to send a requesting UWB signal, so that the runtime on the way to the ID transmitter is the same and only the runtime of the ID transmitter UWB signal on the route from the ID transmitter to the respective UWB antenna is different. Since the UWB control unit knows from which of the UWB antennas the request signal was sent, the UWB control unit can determine the distance of the ID transmitter for each reception signal as long as one of the receiving UWB antennas has also sent the requesting signal. The request is preferably repeated until the requesting antenna has also been able to detect a reception signal. Alternatively, the distance from the runtime “requesting antenna->ID transmitter->receiving antenna” can be determined for different receiving antennas but the same requesting antenna, the inaccuracy in the distance determination resulting from the repeated consideration of the requesting antenna, is neglected, since it is regarded as negligible in comparison to the distance determination accuracy with other methods, for example with LF signal strengths. Independently of this, an LF reception unit of the vehicle is used to determine an LF distance value from a signal strength, for example an RSSI signal strength, of a detected LF signal from the ID transmitter and to transmit this to the UWB control unit. The LF reception unit is coupled to the UWB control unit and can either be part of the communications system or not be part of the communications system. The communication of the vehicle with the ID transmitter is rejected by the UWB control unit as non-authentic communication if the LF distance value and the mean UWB distance value differ from one another beyond a tolerated maximum deviation. In other words, distance information which is generally less precise than a UWB distance determination and is based on LF signal strength is compared with distance information derived from the UWB communication. The comparison contributes to the authentication of the communication between the ID transmitter and the vehicle by checking the consistency of the determined distance information. The fact that distance values based on both an LF signal strength and a UWB runtime are detected means that communication can only be compromised, if at all, with great effort. The fact that a mean value over distance values from all UWB antennas receiving a UWB signal is taken into account reduces a potential influence of possibly existing reflections of individual waves of the UWB signal.

A Provision can be made for the communication between vehicle and ID transmitter to be considered authentic if and only if it is not rejected as non-authentic according to one or more of the above procedures. Alternatively, additional examining bodies can be provided.

For example, 30 percent, preferably 10 percent, of the calculated mean UWB distance value can serve as the tolerated maximum deviation.

According to a further preferred embodiment of the communications system, the first UWB antenna is arranged in a first handle on a driver's door of the vehicle. Alternatively or additionally, the second UWB antenna is arranged in a second handle on a passenger door of the vehicle. The arrangement of one or more UWB antennas within a handle of a vehicle door handle has the advantage that the UWB antenna is elegantly arranged outside the sheet metal casing of the vehicle. As a result, more energy-efficient and qualitatively improved UWB communication is achieved. If the UWB antenna is arranged on the vehicle door handle or within the vehicle door handle, the further advantage is achieved that an operator who is seeking access to the vehicle generally moves toward the driver's door handle for this purpose. Due to the typical operating situation, good conditions for radio communication between the ID transmitter, which is owned by the operator, and the UWB interface are expected.

The arrangement of the UWB antennas within the handles also has the advantage of a wide spacing of the UWB antennas on the vehicle, which results in a comparatively large difference in runtime from the times when the UWB signal is received at the UWB antennas present in the different handles with the advantage of a lower relative error in the determination of the runtime difference.

Last but not least, if the UWB antenna is arranged within a handle, the electronics already present in modern handles can be used, which results in a cost advantage.

It is preferably provided that the UWB antenna and the UWB receiver are part of a UWB transceiver. This has the advantage of a simple and inexpensive implementation.

The communications system preferably has at least three, particularly preferably exactly four, UWB antennas spaced apart from one another.

The communications system particularly preferably has four UWB antennas spaced apart from one another, the directions of maximum reception sensitivity being oriented perpendicular to one another and lying parallel to a driving plane of the vehicle, preferably also lying in one plane.

One idea of the invention relates to an authorization system comprising an ID transmitter and a communications system, the ID transmitter and the communications system being configured with one another in accordance with the above explanation for UWB communication.

Further details, features, and advantages of the object of the invention result from the following description in connection with the drawings. In the drawings, an exemplary embodiment of the invention is shown by way of example.

It goes without saying that the features mentioned above and below can be used not only in the combination indicated but also in other combinations or in isolation.

In the drawings:

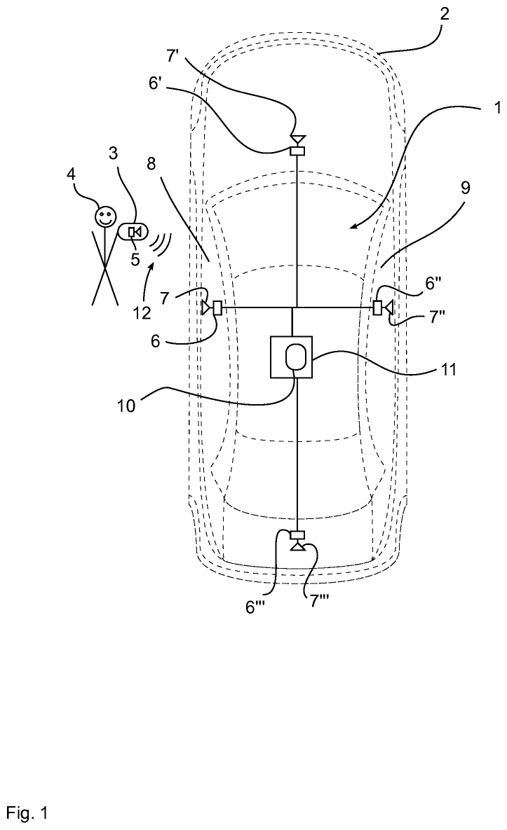

FIG. 1: A schematic diagram of a communications system according to the invention;

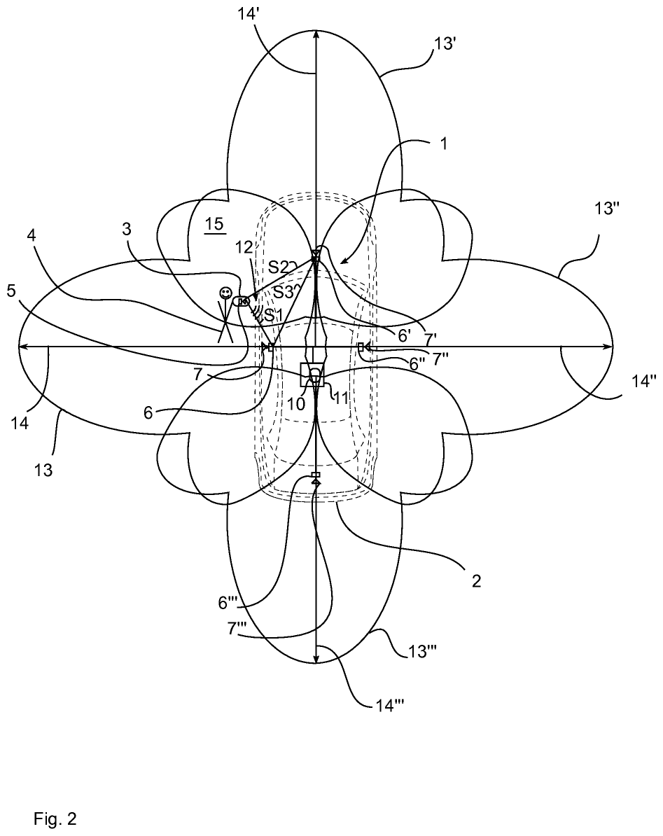

FIG. 2: Another schematic diagram of the communications system according to the invention from FIG. 1.

FIG. 1 shows an exemplary embodiment of a communications system 1. The individual structural components of the communications system 1 are arranged on a vehicle 2. With the communications system 1, the vehicle 2 is at least enabled for UWB communication with a portable ID transmitter 3. UWB communication is used, for example, to activate vehicle functions for an operator 4 who carries the ID transmitter 3 with him. The ID transmitter 3 is portable, i.e. can be carried by the operator 4 without any aids. The ID transmitter 3 is also configured for UWB communication. The ID transmitter 3 thus has communication means which enable the ID transmitter 3, among other things, for UWB communication. For example, these communication means can be a UWB transceiver 5 that has a UWB antenna. The ID transmitter 3 is not part of the communications system 1 of the present invention. However, the ID transmitter 3 and the communications system 1 are configured for UWB communication with one another, that is to say that all the necessary hardware and software requirements are provided such that the operator 4 can be authenticated by means of the ID transmitter 3 by using UWB communication between the ID transmitter 3 and communications system 1 on the vehicle as being authorized to grant functionality.

The communications system 1 has a first UWB receiver 6, which is coupled to a first UWB antenna 7. Furthermore, a second UWB receiver 6′ having a second UWB antenna 7′ and two further UWB receivers 6″, 6′″ each having a further UWB antenna 7″, 7′″ are arranged on the vehicle. The UWB antennas 7, 7′, 7″, 7′″ are arranged on the vehicle 2 at a distance from one another. In particular, the first UWB antenna 7 in the embodiment shown is arranged in a first handle on a driver's door 8 and the third UWB antenna 7″ is arranged in a second handle on a passenger's door 9. The handles are not shown due to the schematic representation.

The UWB receivers 6, 6′, 6″, 6′″ are coupled to a central UWB control unit 10 of the vehicle 2, the coupling being wired in the example shown. In the embodiment shown, the central UWB control unit 10 of the vehicle 2 is part of a central control unit 11 of the vehicle 2. However, it is also conceivable that the UWB control unit 10 is designed as a separate unit from the central control unit 11.

When the operator 4 approaches the vehicle, authentication of operator 4 is carried out as a prerequisite for enabling functions of vehicle 2 for the operator 4. This is initially done, for example, according to a procedure known from practice. Such a known method sequence provides, for example, that a low-frequency LF wake-up signal is first emitted by the vehicle 2. The LF wake-up signal switches the ID transmitter 3, which is prepared for receiving LF wake-up signals, from an energy-saving mode into an active mode. In response to the LF wake-up signal, the ID transmitter 3 initiates UWB communication with the vehicle-side control unit 11. The UWB communication takes place by means of the UWB transceiver 5 of the ID transmitter 3. In the course of the UWB communication between the ID transmitter 3 and the motor vehicle control unit 11, for example, there is a mutual exchange of encrypted information and its verification by the other communication partner involved. Alternatively, it is of course also conceivable that the UWB communication is initiated by the vehicle-side central control unit 11 or by the UWB control unit 10 in response to an LF or HF request from the ID transmitter.

During UWB communication, the ID transmitter 3 sends out an ID transmitter UWB signal 12. In many cases, the ID transmitter UWB signal 12 is the response to a vehicle UWB signal. Both the first UWB antenna 7, which is coupled to the first UWB receiver 6, and the second UWB antenna 7′, which is coupled to the second UWB receiver 6′, receive the ID transmitter UWB signal 12. The first reception signal of the ID transmitter UWB signal 12 received by the first UWB receiver 6 and the second reception signal of the ID transmitter UWB signal 12 received by the second UWB receiver 6′ are transmitted to the central UWB control unit 10. The central UWB control unit evaluates both signals together for plausibility.

FIG. 2 shows the limit lines of the reception capability of the first UWB antenna 13, the second UWB antenna 13′, the third UWB antenna 13″, and the fourth UWB antenna 13′″. Outside the illustrated border lines, UWB communication of the specific ID transmitter 3 with the specific UWB antenna is no longer possible; the course of the border lines is therefore always dependent on the specific design of the individual components of the communications system 1 and the ID transmitter, whereby the communications system is configured for use with an appropriately suitable ID transmitter. The point of reception capability furthest from the UWB antenna defines the direction of maximum reception sensitivity based on the respective UWB antenna. These directions are symbolized by the arrows 14, 14′, 14″, 14′″. It can be seen that the UWB antennas 7, 7′, 7″, 7′″ have a pronounced directional characteristic, the direction of the maximum reception sensitivity in the exemplary embodiment shown being an axis of symmetry of a main lobe of the respective UWB antenna 7, 7′, 7″, 7′″. In the embodiment shown, the directions of the maximum reception sensitivity of two adjacent UWB antennas are oriented perpendicular to one another as a result of the selection of the UWB antennas, the orientation of the UWB antennas, and their positioning on the vehicle.

It can also be seen that two adjacent UWB antennas each provide an overlap space in the embodiment shown. For example, the regions with a minimum reception sensitivity of the first antenna 7 and the second antenna 7′ form an overlap space 15 within which both the first UWB antenna 7 and the second UWB antenna 7′ can receive a transmitted UWB signal from the ID transmitter 3. In other words, due to the selection, positioning, and orientation of the UWB antennas and the selection of a UWB communication arrangement of the ID transmitter within the overlap space 15, UWB communication of the ID transmitter 3 with the vehicle 2 is both possible via the first UWB antenna 7 and also via the second UWB antenna 7′. Of course, the selection, positioning, and orientation of the antennas can be modified by the person skilled in the art, for example orientations, selection, and positioning can also be provided in which overlap spaces exist within which communication with all available UWB antennas is possible. In accordance with the above explanations, the specific dimensioning of the overlap space thus depends both on the specific type and positioning of the UWB antennas and on the selection of the ID transmitter. However, since the authorized ID transmitter 3 must be known to the vehicle 2 anyway, the person skilled in the art can select and position and control the UWB antennas with knowledge of one or more types of ID transmitters without this being particularly difficult for him.

Because UWB communication of the ID transmitter 3 within the overlap space 15 is possible both with the first UWB antenna 7 and with the second UWB antenna 7′, the central UWB control unit 10 is provided with both a first reception signal of the ID transmitter UWB signal 12 and a second reception signal of the ID transmitter UWB signal 12. The central UWB control unit 10 is thereby enabled to evaluate the authenticity of the received ID transmitter UWB signal 12 according to its configuration and to take into account both the first and the second reception signal of the same ID transmitter UWB signal 12 in the evaluation.

In the embodiment shown, the overlap space 15 is adapted by the person skilled in the art to provide the object according to the invention in such a way that the communication of the ID transmitter UWB signal with the first UWB antenna 7 and the second UWB antenna 7′ is possible at one position of the operator 4, which he assumes when he approaches the driver's door 8. A narrowly defined limitation of the overlap space 15 is not important as long as it is ensured that, in the course of the operating behavior provided by the developers, an ID transmitter UWB signal transmitted by the ID transmitter 3 is received with a sufficient signal strength for communication and for signal evaluation both on the first UWB antenna 7 and on the second UWB antenna 7′. This ensures that with a natural operating behavior of the operator 4, the specifications of the central UWB control unit 10 configured according to the invention can be implemented by the latter.

In particular, in the embodiment shown it is provided that communication of the vehicle 2 with the ID transmitter 3 is rejected as non-authentic communication if a runtime difference of a runtime value of the UWB signal on route S1 and the UWB signal on route S2 is greater than a runtime value corresponding to the distance between the first antenna 7 and the second antenna 7′, S3. In this case it can be concluded that at least one of the UWB signals has traveled a different route than the route S1 or the route S2 or that one of the signals could have been manipulated.

A communications system 1 of a vehicle 2 is therefore shown in a preferred embodiment, the preferred embodiment having four UWB antennas 7, 7′, 7″, 7′″ spaced apart from one another, whose directions of maximum reception sensitivity are selected to be oriented perpendicularly to one another and lying in parallel to a driving plane of the vehicle 2. Two adjacent UWB antennas form an overlap space, the respective overlap space ensuring that an ID transmitter 3 located near the vehicle can carry out UWB communication with the vehicle 2 via at least two of the UWB antennas of the vehicle 2. This ensures that improved security is achieved before an authentication of the ID transmitter 3 is compromised.

For a specific embodiment, the person skilled in the art entrusted with the implementation offers many methods for implementing the communications system according to the invention. In particular, by means of targeted selection of the antennas, targeted arrangement of the antennas on the vehicle, and reception characteristics of the individual UWB antennas that are optimized for desired applications, environmental spaces designated according to the invention as overlap spaces can be provided, within which an ID transmitter UWB signal of two or more than two UWB antennas is received.

Various methods for testing the authenticity of the communication of the vehicle 2 with the ID transmitter 3 can be implemented to validate the reception signal, wherein, depending on the security requirements, the simultaneous fulfillment of a plurality of conditions can serve as a prerequisite for enabling vehicle functions.

1. Communications system of a vehicle for the communication of the vehicle with a portable ID transmitter, which is configured for UWB communication, for enabling vehicle functions for an operator who carries the portable ID transmitter,
wherein the communications system includes at least a first UWB receiver having a first UWB antenna and a second UWB receiver having a second UWB antenna,
wherein the first UWB antenna and the second UWB antenna are arranged at a distance from one another on the vehicle,
wherein a central UWB control unit of the vehicle is coupled to the first UWB receiver and to the second UWB receiver,
wherein the central UWB control unit is configured to evaluate both a first reception signal of an ID transmitter UWB signal received by the first UWB antenna and a second reception signal of the same ID transmitter UWB signal received by the second UWB antenna as a function of one another for an authentication of the communication of the vehicle with the ID transmitter.

2. Communications system according to claim 1, wherein the direction of a maximum reception sensitivity of the first UWB antenna and the direction of a maximum reception sensitivity of the second UWB antenna are oriented at an angle to one another which angle is at least 30 degrees.

3. Communications system according to claim 1, wherein the direction of a maximum reception sensitivity of the first UWB antenna and the direction of a maximum reception sensitivity of the second UWB antenna are oriented at an angle to one another which angle is at most 120 degrees.

4. Communications system according to claim 1, wherein there is an overlap space in front of a driver's door of the vehicle, within which a reception sensitivity of the first UWB antenna and a reception sensitivity of the second UWB antenna exceed a minimum value at each location, whereby
an extension of the overlap space,
the selection, positioning and orientation of the UWB antennas as well as
the selection of a UWB communication arrangement of the ID transmitter
are adapted to one another in such a way that for the ID transmitter, UWB communication of the ID transmitter with the vehicle via both the first UWB antenna and the second UWB antenna can be carried out at least when the ID transmitter is positioned within the overlap space.

5. Communications system according to claim 1, wherein the UWB control unit is configured to evaluate a first runtime value of the first reception signal and a second runtime value of the second reception signal by means of N-lateration.

6. Communications system according to claim 1, wherein the UWB control unit is configured to determine a first runtime value of the first reception signal and a second runtime value of the second reception signal, wherein the communication between the ID transmitter and the vehicle is rejected as non-authentic communication if a runtime difference between the first runtime value and the second runtime value exceeds a maximum runtime by more than a tolerated deviation, the maximum runtime being the time required for traveling of the distance between the first UWB antenna and the second UWB antenna.

7. Communications system according to claim 1, wherein the UWB control unit is configured,
to determine a runtime value for each of the detected reception signals and to calculate a mean runtime value from the determined runtime value, and/or
to determine a signal strength value for each of the detected reception signals and to calculate a mean signal strength value from the determined signal strength values,
wherein a mean UWB distance value is derived from the mean runtime value and/or the mean signal strength value,
wherein an LF distance value is determined from a signal strength of a detected LF signal of the ID transmitter, the communication between the ID transmitter and the vehicle being rejected as non-authentic communication, if the LF distance value and the mean UWB distance value deviate from one another beyond a tolerated maximum deviation.

8. Communications system according to claim 7, wherein the tolerated maximum deviation is less than 30 percent, of the calculated mean UWB distance value.

9. Communications system according to claim 1, wherein the UWB control unit is configured to reject the communication between the ID transmitter and the vehicle as non-authentic communication, if only one of the UWB antennas detects a reception signal of the ID transmitter UWB signal.

10. Communications system according to claim 1, wherein the first UWB antenna is arranged in a first handle on a driver's door of the vehicle and/or the second UWB antenna is arranged in a second handle on a passenger door of the vehicle.

11. Communications system according to claim 1, wherein at least three spaced-apart UWB antennas are arranged on the vehicle.

12. Communications system according to claim 10, wherein four spaced-apart UWB antennas are arranged on the vehicle, the directions of maximum reception sensitivity being selected to be oriented perpendicular to one another and to be parallel to a driving plane of the vehicle.

13. Communications system according to claim 8 wherein the tolerated maximum deviation is less than 10 percent of the calculated mean UWB distance value.

14. Communications system according to claim 11 wherein at least four spaced-apart UWB antennas are arranged on the vehicle.
